(19) United States
(12) Patent Application Publication
(10) Pub. No.: US 2019/0249691 A1
(43) Pub. Date: Aug. 15, 2019

(54) Aquelectraduct

(71) Applicants: Spencer B. Carter, JR., Flowery Branch, GA (US); Matthew Ryan Carter, Plant City, FL (US)

(72) Inventors: Spencer B. Carter, JR., Flowery Branch, GA (US); Matthew Ryan Carter, Plant City, FL (US)

(21) Appl. No.: 15/932,145

(22) Filed: Feb. 12, 2018

(51) Int. Cl. F04F 10/02; F03B 13/08; E02B 1/00; E02B 9/06

(52) U.S. Cl. CPC F04F 10/02; E02B 9/06; E02B 1/003; F03B 13/086

(57) ABSTRACT

This invention uses atmospheric pressure and gravity, only to power a new energy system. Renewable, clean energy from new sources is much needed in the U.S. and the world today. Many possible locations exist in the U.S. that this new system can be installed. If the potential of this new system is fulfilled, the country's economy will benefit greatly over the next many years. Thousands of permanent jobs will be created.

### (1) ABSTRACT OF THE DISCLOSURE

The Aquelectraduct (A.Q.E.D.) a system that generates energy from water. A pipeline configured as a siphon extends from a upper lake, to a lower aqueduct with a pluration of energy generating equipment, extending a distance of space available. The diameter of the pipeline and the length of the aqueduct make the A.Q.E.D. a powerful energy system, that functions continuous.

### (2) BACKGROUND OF THE INVENTION

Over 80,000 dams/lakes have been built in the U.S. over the past (100) years. Many of the dams have single pipeline drainage through their bottom, with hydroelectric generators connected, providing limited energy. The Aquelectraduct is specifically designed to be installed on existing lakes, improving their energy production.

### (3) BRIEF SUMMARY OF THE INVENTION

The (A.Q.E.D.) is a energy system that functions as a machine. Water goes in one end and energy comes out the other. The siphon effect is put into place, taking full advantage of its (32) ft limit in height. The extended aqueduct with its plurality of energy equipment gives this machine huge capacity, and the title of energy system.

### (4) DETAILED DESCRIPTION OF THE INVENTION

The A.Q.E.D. has four (4) major parts that allows it to function. A port, pipeline, control unit and aqueduct. The minimum size of a A.Q.E.D. pipeline is (10) ft in diameter. The apex (its top side) of the pipeline extends out and over the lake approx. (2) ft above the lakes full pool, parallel with the water. It then turns ninety degrees downward for (32) ft, (20) ft deep in the lake water at full pool. This (32) ft section of the pipeline is its snout. At the end of the snout is the pipeline mouth. The mouth, snout, and apex form the port of the pipeline. The port of the pipeline is configured as a siphon. Its (32) ft snout is the limit in height that a water siphon can function. The apex extends into the embankment, underground for short distance, then angles downward still underground, on a line that will carry it around and past the dam. The pipeline then extends down to the drainage river (D.R.) below the dam, where it connects to the control unit (C.U.). The C.U. has a main valve between it and the end of the pipeline. The C.U. is parallel with the D.R. and connects to the aqueduct on its other end. The C.U. has a suction device on its top side for priming. It also has a removable plate between it and the aqueduct, needed to seal the C.U. during priming. The aqueduct extends down one side, and level with the D.R., to a distance of space available. The aqueduct is made in (approx) (60) ft long channel sections, connected together and centered over columns. The inside dimension of the channels is (8) ft high by (15) ft wide. One water wheel and two generators will be mounted inside the channel section, centered over the columns. A (10) ft dia. Pipeline will produce a volume of water (5) ft deep by (15)) ft wide inside the aqueduct. An aqueduct with (60) ft sections, (2,600) ft long (½ mile), will house (43) waterwheels and (86) generators.

To prime the pipeline, the valve is to be open, and the removable plate secured. The suction device will draw out all air from inside the pipeline and C.U. turning it into a vacuum. Atmospheric pressure, pressing down on the lake will force the lake water into the pipeline completely filling the vacuum. (Water is weightless inside a vacuum) Once water reaches the C.U., the suction device is turned off, the valve closed, and the plate is removed. The system is primed. A large volume of water is trapped between the mouth and valve of the pipeline held in place by atmospheric pressure and gravity. The system can now be turned off and on with one valve. It never needs priming again.

### (5) BRIEF DESCRIPTION OF THE SEVERAL VIEWS OF THE DRAWING

FIG. 1) A perspective plan view of the Aquelectraduct, implementing is four major parts, the port, pipeline, control unit, and aqueduct.

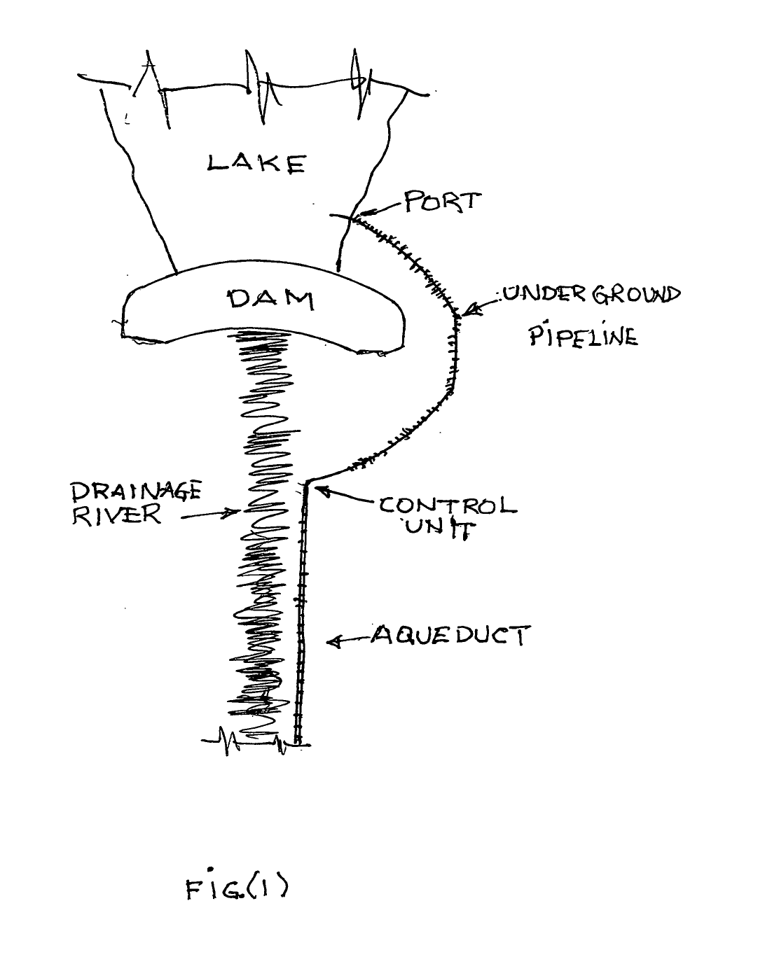

FIG. 2) A side elevation view of the port, implementing the pipeline and its mouth, snout, and apex.

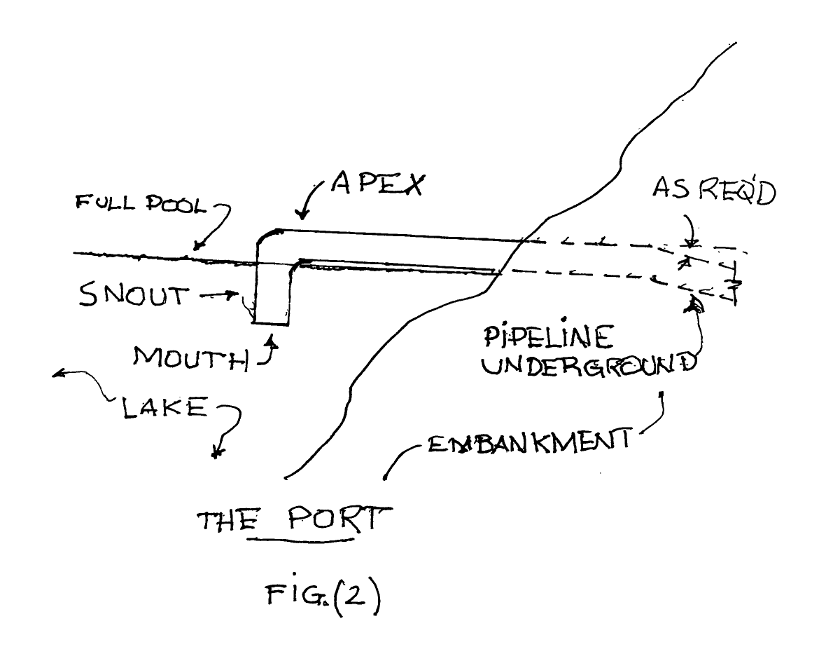

FIG. 3) A side elevation view of the control unit, implementing the valve, suction device, removable plate, pipeline and aqueduct.

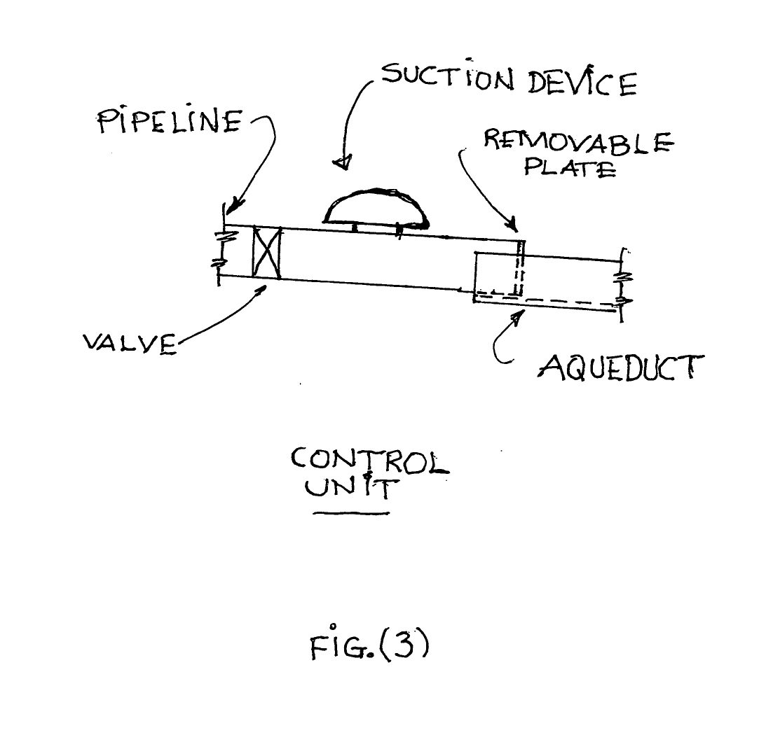

FIG. 4) A side elevation view of the aqueduct, implementing, the water wheel generators; centered connection, structural column and water depth.

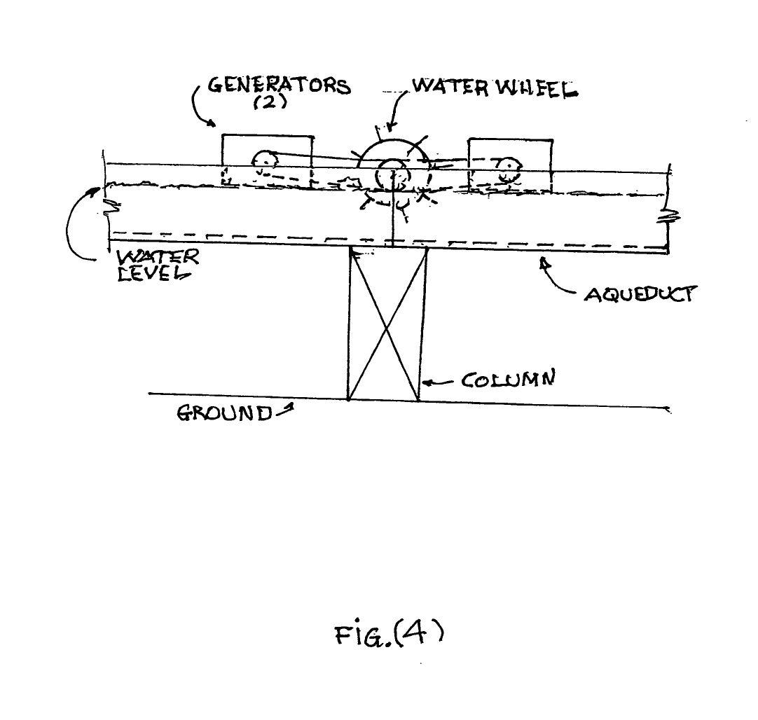

### (6) CROSS REFERENCE RELATED APPLICATIONS

Application, US 2014/0193201 A1, Jul. 10, 2014, Stauffer, D. W., on page (3) paragraph (0029) Stauffer states: “For water, at standard atmospheric pressure, the maximum siphon height is approx. 10M (32 feet)”. Stauffer's sources are stated.

Application, US 20120187692-A1, July 2012, Walton, R. D., discloses three siphon situations, FIGS. (18) (19) (20). He never mentions or indicates any knowledge of siphon limits. All three situations show the siphon extending over the top of the dam, in a new construction setting. If his drawing were to scale, the siphon lines would be too small in diameter, to be effective.

On his drawings, he shows the primer pump (1344) and valve (1347) above the mouth of the siphon line. The siphon effect cannot take place unless these items are below the altitude of the mouth. If the three drawings were correct, with (1344) and (1347) below the mouth, the three siphon lines (1340), (1400), (1540) would be higher, and the scale problem very clear.

Walton's statement in paragraph (0186) states: “hydroelectric generators may include siphons that extend to any depth within a liquid source”. Walton did not know of the (32) ft. limit.

All three of Walton's siphon situations are conditional. FIGS. 18 & 19 are based on water levels falling below penstock. FIG. 20 could never be a drainage system with a premise of keeping the lake near full pool. Its siphon would be too small in diameter.

### (7) STATEMENT OF FEDERAL, SPONSORED RESEARCH AND DEVELOPMENT

None

### (8) THE NAME OF THE PARTIES TO A JOINT AGREEMENT

None

### (9) REFERENCE TO A SEQUENCE LISTING

None

1) A turn key energy system; comprising of a (10) ft diameter (minimum) pipeline and extended aqueduct configured to siphon a volume of water (5) ft deep by (15) wide through a plurality of water wheels and generators, generating energy.

2) Outdated hydroelectric systems; comprising of over 80,000 built in the U.S. over past (100) years, to be targeted for A.Q.E.D. projects improving energy production.

3) A second drainage system; comprising of a (10) ft. diameter (minimum) siphon pipeline, extending underground around a dam keeping lakes full pool and spillways never used.

4) Atmospheric pressure and gravity, wherein the improvement comprises: the A.Q.E.D. uses no fossil fuel, only the siphon effect, and a single control valve, allows the system to function continuous.
